(19) United States
(12) Patent Application Publication
(10) Pub. No.: US 2007/0120852 A1
(43) Pub. Date: May 31, 2007

(54) Method for interpolating volume data

(76) Inventor: Robert Schneider, Rosstal (DE)

Correspondence Address: HARNESS, DICKEY & PIERCE, P.L.C., P.O.BOX 8910, RESTON, VA, 20195, US

(21) Appl. No.: 11/602,269

(22) Filed: Nov. 21, 2006

(30) Foreign Application Priority Data
Nov. 22, 2005 (DE) 10 2005 055 665.5

(51) Int. Cl. G06T 17/20; G06T 15/30

(52) U.S. Cl. 345/423

(57) ABSTRACT

In the case of a method for interpolating volume data, the values of interpolation points that are to be assigned to a set of scanning points are buffered in a linear storage area. It is thereby possible to prevent stalling the pipeline of a processor used to carry out an embodiment of the method, and to dispense with time consuming instructions for transmitting data between registers of different size.

### PRIORITY STATEMENT

The present application hereby claims priority under 35 U.S.C. §119 on German patent application number DE 10 2005 055 665.5 filed Nov. 22, 2005, the entire contents of which is hereby incorporated herein by reference.

### FIELD

The invention generally relates to a method interpolating volume data. For example, it may relate to a method for interpolating volume data in the case of which a processor is used to determine the interpolation points assigned to a set of scanning points, and in the case of which an interpolation is performed from interpolation point values of the interpolation points to the scanning point values to be assigned to the scanning points.

### BACKGROUND

Known methods are used when working with discrete volume data. The volume data are assigned in this case to discrete volume elements, the so-called voxels. The volume data can be both scalars and vectors. In the case of a three-dimensional model of a body part compiled with the aid of computed tomography, the volume data can, for example, relate to the density of the examined body part.

If the aim is to take a slice through the three-dimensional model, the volume data must be interpolated onto the grid of the slice. The grid of the slice is defined by scanning points according to which it is necessary to interpolate from interpolation points of the original volume data. In order to be able to execute the interpolation, it is necessary to determine the interpolation points adjacent to the scanning points from which it is possible to interpolate to the scanning points. Ordinal data of the adjacent interpolation points are firstly determined for this purpose. The ordinal data can be one-dimensional or multidimensional indices, keywords with alphanumeric characters, physical addresses or the like.

It is fundamentally a problem of determining those volume elements in which a set of scanning points lies, and of interpolating these volume elements onto the position of the scanning points. The set of scanning points can lie in this case on a curve, on a two-dimensional surface or also in a volume region.

The procedure to date is to determine for each scanning point the associated space element or voxel in which the scanning point lies and to carry out the interpolation immediately thereafter. The scalar determination of the relevant space element and the subsequent immediate interpolation require a high computational outlay, since the calculation must be carried out serially for a large number of space points.

Modern processors for workstation computers are, however, also capable of carrying out vector operations for the processing of image data. During vector operations, data are processed in parallel by means of a single instruction (SIMD=Single Instruction Multiple Data). The use of vector operations for the interpolation assumes, however, that the data required for carrying out the interpolation are present in linear form in the memory, which is, of course, not the case when interpolating onto a set of scanning points that lies along an arbitrary curve.

As a rule, scalar operations for resorting or collecting data therefore need to be inserted between the determination of the indices and the actual interpolation. It is certainly fundamentally necessary in this case to use instructions that enable data to be exchanged directly between the registers for vector operations and the scalar registers. However, such instructions are very time consuming and so the time gained through the use of vector operations is lost again.

### SUMMARY

In at least one embodiment of the invention, a method is provided for effectively interpolating volume data.

In at least one embodiment, the method is distinguished in that the interpolation point values of the determined interpolation points are buffered in a linear interpolation value storage area of a memory unit, and in that vector operation is used to interpolate to the scanning points.

In this context, a linear storage area is intended to be understood as a storage area that can be read to or read out incrementally on a physical plane. Furthermore, memory unit is, in particular, intended to be understood as a data memory with optional access.

Although the buffering of data in a linear storage area is associated with a certain time outlay, writing into the linear storage area can generally be performed at high speed, and the time that is additionally required can be made up again in the subsequent calculations with the aid of vector operations, and so considerably less time is required overall. In particular, preceding scalar operations can be written into the storage area, and subsequent calculations can access linearly stored data with vector operations.

Consequently, subsequent calculations can also execute vector operations by which a multiplicity of data can be processed in parallel. It follows overall that time is spared when buffering in a linear storage area by comparison with a purely scalar method or a method in which data is exchanged between scalar registers and vector registers.

In an example embodiment, the storage of the interpolation point values in the linear storage area is optimized for access with the aid of a vector operation. It is thereby possible for the data to be read out at high speed from the linear storage area and transmitted into the linear storage area.

In a further example embodiment, the storage area is filled with a larger data set of interpolation values than can be read out or written to by an individual vector operation. In this case, the memory accesses, which are performed to different extents, can be carried out with a sufficient time spacing to avoid the occurrence of an event that is known to the person skilled in the art by the term “fast forward violation” and causes the processor to be stalled, since it must be ensured that no collisions occur between the operations accessing the same storage area to different extents.

In order to accelerate an example embodiment of the method, vector operations are used at the start of the method to firstly determine ordinal data of the interpolation points to be assigned to the scanning points, and the results are stored in a linear ordinal data storage area. Subsequent scalar operations, by which the interpolation point values are read out from the memory, sorted if appropriate and stored in the interpolation value storage area can then access the ordinal data storage area without a being triggered.

The ordinal data storage area can also be optimized for accessing data via vector operation. Furthermore, the ordinal data storage area is preferably filled with a larger set of ordinal data than can be written into the ordinal data storage area by means of individual vector operations.

### BRIEF DESCRIPTION OF THE DRAWINGS

Further properties and advantages of the invention emerge from the following description, in which example embodiments of the invention are explained in detail with the aid of the attached drawings, in which:

FIG. 1 shows a block diagram of a medical device;

FIG. 2 shows a two-dimensional region of space that is traversed along a straight line;

FIG. 3 shows a block diagram of a microprocessor; and

FIG. 4 shows a flowchart of an interpolation method.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

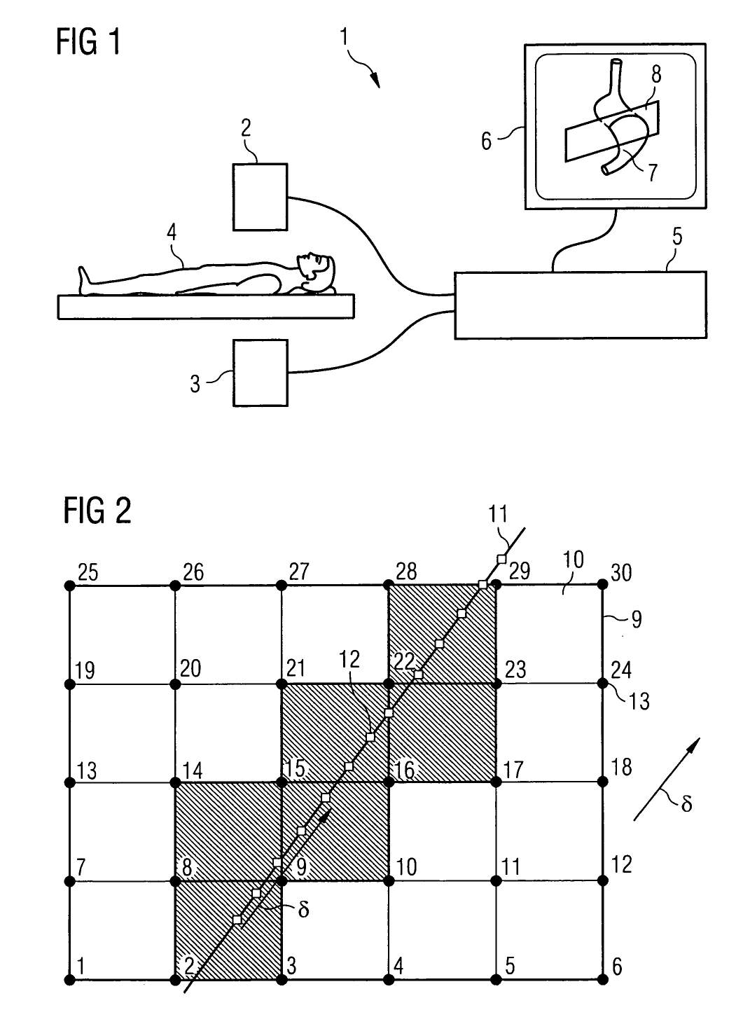

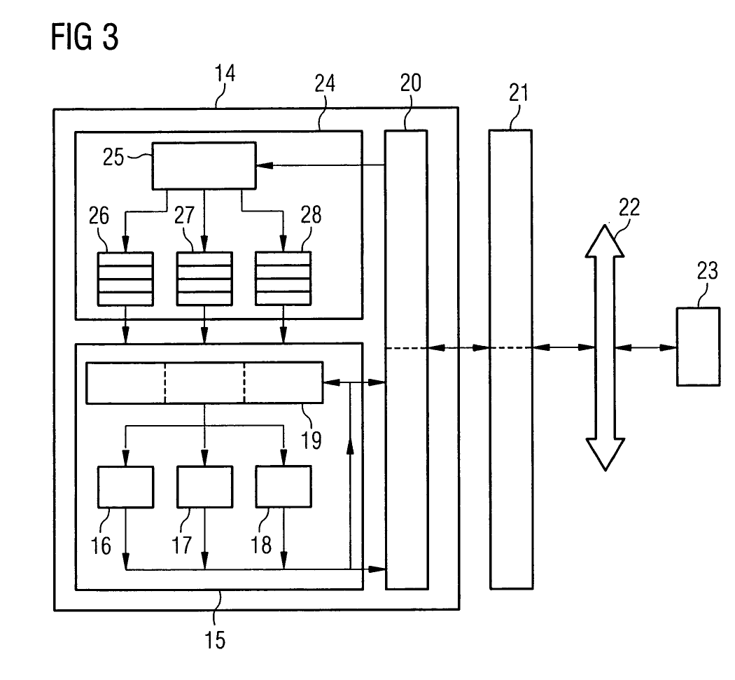

FIG. 1 shows a medical diagnostic unit which is, for example, a unit for magnetic resonance tomography. Such a medical diagnostic unit comprises, inter alia, a microwave transmitter 2 and a microwave receiver 3, as well as a device (not illustrated in FIG. 1) for generating a strong magnetic field that penetrates the body of a patient 4 who is to be examined. Three-dimensional models of the body interior of the patient 4 can be compiled with the aid of the signals received by the microwave receiver 3 after the emission of a microwave pulse by the microwave transmitter 2. It is customary to evaluate the signals by using a computer 5 that indicates the results on a display screen 6. In FIG. 1, the display screen 6 shows a three-dimensional display of an internal organ 7 of which a slice view is to be prepared along a slice plane 8. Use is made in this case, by way of example, of a method that is known to the person skilled in the art by the term multiplanar reconstruction (=MPR).

In the course of this example method, it is necessary for the volume data that represents the organ 7 to be interpolated in order to be able to generate the volume data on the grid of the slice plane 8.

For the sake of simplicity, FIG. 2 illustrates a two-dimensional volume 9 that is composed of twenty voxels 10. Laid through the volume 9 is a slice line 11 that has twelve scanning points 12 inside the volume 9. The aim of the scanning points 12 is to determine the volume data by interpolating volume data assigned to the scanning points 12. To this end, it is necessary to determine those interpolation points 13 that lie closest to the scanning points 12.

The interpolation points 13 are marked in FIG. 2 by black circles. A total of 30 interpolation points are depicted in FIG. 2. The interpolation points 30 relevant to the interpolation are those that are assigned to the corners of the voxels 10 hatched in FIG. 2.

It may further be remarked that the slice line 11 in FIG. 2 corresponds to the slice plane 8 in FIG. 1.

Fundamentally, it will be possible to proceed with interpolating volume data such that the voxel 10 associated with a scanning point 12 is first determined, and then an interpolation is performed onto the scanning point 12 from the volume data assigned to the voxel 10. However, such a mode of procedure is not optimum, since possibilities of modern processors are not utilized.

The architecture of a processor 14 may therefore be considered below.

The processor 14 includes an arithmetic and logic unit 15 that has an arithmetic element 16 for integer operations, an arithmetic element 17 for floating point operations and an arithmetic element 18 for vector operations. Furthermore, the arithmetic and logic unit 15 includes registers 19 from which the arithmetic elements 16 to 18 can read out data and into which the arithmetic elements 16 to 18 can return data for storage.

Furthermore, in order to buffer the dataflow, the processor 14 includes a first-order cache 20 that exchanges data with a second-order cache 21. The cache 21 is connected to a bus system 22 that is also connected to a main memory 23. Instructions contained in the first-order cache 20 can be fetched by an instruction unit 24. The instruction unit 24 includes, inter alia, an instruction decoder 25 that converts the instructions into microcode and assigns the microcode to a pipeline 26, 27 or 28. The microcode contained in the pipelines 26 to 28 is used to control the arithmetic and logic unit 15, particularly the arithmetic elements 16 to 18. It may be remarked that the pipelines 26 to 28 can also be classed with the arithmetic and logic unit 15.

The arithmetic element 18 for vector operations is particularly important for the processing of image data. The point is that this arithmetic element can be used to read out a number of data items stored relative to a pixel in the register 19 by way of a single instruction, and to process them. It is therefore possible in principle to execute the scanning points 12 from FIG. 2 with the aid of arithmetic operations. However, this presupposes that the data to be processed are present linearly in the memory, in particular in the second-order cache 21 or in the main memory 23. This is not the case, of course, when the scanning points 12 lie along an arbitrary curve through the volume 9.

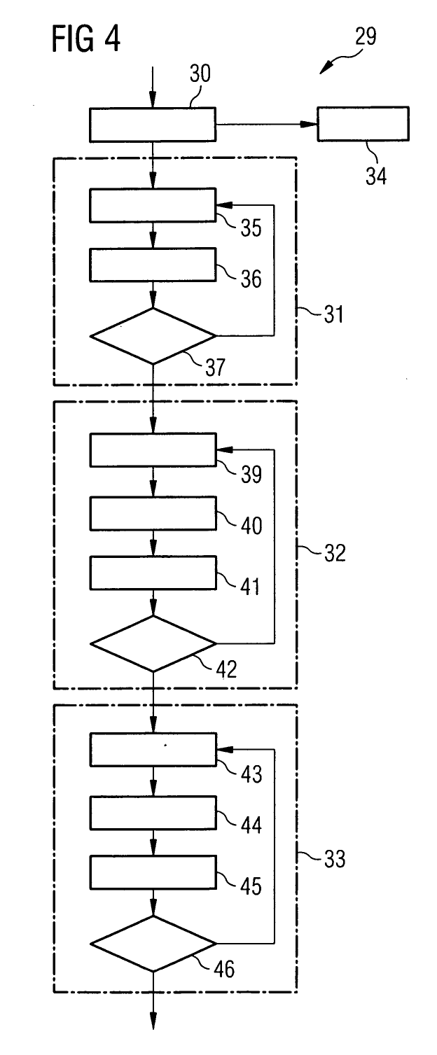

FIG. 4 therefore illustrates an interpolation method 29 that is structured in accordance with a multipass strategy. The interpolation method 29 begins with a check 30 and is otherwise subdivided into a first pass 31, a second pass 32 and a third pass 33. The relevant interpolation points 13 are determined in the first pass 31. The associated interpolation values are read out in the second pass 32, and the actual interpolation is performed in the third pass 33.

During checking 30 at the start of the interpolation method 29, it is established whether the scanning points 12 lie within the volume 9. Treatment 34 as a special case is necessary when the scanning points lie outside the volume 9 or at the edge of the volume 9. If the scanning points 12 are located outside the volume 9, the value for the scanning points can be set to a standard value, for example 0. When the scanning point 12 is located at the edge of the volume 9, use is made of the special interpolation method that manages with few interpolation points 13. The special interpolation method can be carried out in accordance with previous approaches to the solution.

The second pass 32 can, however, be adapted for an edge situation. For example, interpolation point values can be extrapolated from interpolation points 13 lying in the interior of the volume 9 such that the scanning points 12 lying at the edge of the volume 9 can be treated as scanning points 12 that lie in the interior of the volume 9. The treatment of the scanning points 12 lying in the edge region is not essential for the speed and efficiency of the interpolation method 29, since in practice virtually all the scanning points 12 lie within or outside the volume 9.

In the first pass 31, the first step is to carry out a voxel determination 35 by which those voxels 10 are determined in which the scanning points 12 lie. In the course of the voxel determination 35, it is possible, for example, to determine the ordinal numbers of those voxels 10 in which the scanning points 12 lie. The ordinal numbers can be one-dimensional or multidimensional indices, keywords with alphanumeric characters, physical addresses or the like. Furthermore, it is also possible to determine the memory address of an individual adjacent interpolation point 13 when the memory addresses of the remaining relevant interpolation points 13 are fixed thereby. In the case of a trilinear interpolation in three-dimensional space, it is, for example, sufficient to determine the memory address of one of the eight interpolation points 13 required for carrying out the interpolation. The addresses of the remaining interpolation points 13 can then be determined from the address of the determined interpolation point 13.

The voxel determination 35 can be carried out efficiently with the aid of vector operation by determining a number of ordinal data items simultaneously. The ordinal data obtained can be stored in a linear data field (=array) by saving 36. The vector operations may be carried out, for example, with the aid of SIMD.

Vector operations can be used for determining ordinal data particularly when the scanning points 12 can be calculated incrementally.

The ordinal data field A1 is aligned such that it is possible to write to the ordinal data field A1 with the aid of the fastest possible vector instructions.

It may be remarked that the ordinal data can also include a number of information items per scanning point 12. When the voxels of the volume are present in the second-order cache 21 or in the main memory 23 not linearly but in a slicepoint fashion, both the index for the slice and the index within the slice are stored per scanning point 12 in the ordinal data field A1. What is required fundamentally is to have enough information present so that the voxel 10 assigned to a scanning point 12 is uniquely fixed.

A predetermined set of scanning points 12 is processed in the first pass 31. Consequently, stationed at the end of the first pass 31 is an interrogation 37 with the aid of which it is established whether there are still further scanning points 12 to be processed. If this is the case, the remaining scanning points 12 are also processed before starting with the second pass 32.

In the second pass 32, the ordinal data determined in the first pass 31 are used to perform a determination 39 of interpolation values by which the interpolation values required for the interpolation are determined. The ordinal data required for the determination 39 of interpolation values are read out in this case from the ordinal data field A1. If appropriate, a sorting operation 40 is also carried out by which the determined interpolation values are sorted such that the subsequent third pass 33 can be carried out with the aid of vector operation.

Finally, the determined and sorted interpolation values are transmitted by saving 41 into an interpolation value data field A2. A number of interpolation operations can now be carried out in parallel in the following third pass 33 with the aid of vector operation.

In order to be able to read out the interpolation value data field A2 as quickly as possible, the interpolation value data field A2 is aligned such that it is possible to read from the interpolation value data field A2 with the aid of the fastest possible vector instructions.

It may be remarked that the second pass 32 must be carried out predominantly with scalar instructions that access scalar registers. The second pass 32 is, however, carried out for all the scanning points 12 of the predetermined set of scanning points 12 before starting with the third pass 33. Consequently, at the end of the second pass 32 there is an interrogation 42 with the aid of which it is checked whether all the scanning points 12 of the predetermined set of scanning points 12 have been processed.

The third pass 33 begins with a parameter determination 43 with the aid of which the parameters required for interpolation, for example the parameters λ_x, λ_y and λ_z in the case of a three-dimensional volume, are determined. The parameters are yielded from the coordinates of the scanning points 12 relative to the interpolation points 13. The coordinates of the scanning points 12 are stored in registers for vector operation such that it is possible to determine the interpolation parameters by vector operation from the coordinates of the interpolation points 13. The interpolation parameters are present in registers for vector operation as a result of the parameter determination 43.

Subsequently, the actual bilinear or trilinear interpolation 44, by means of which the values of the interpolation points 13 are interpolated onto the scanning point 12, is performed. The result is rounded, if appropriate, and written into an output data field A3 by saving 45. At the end of the third pass 33 there is an interrogation 46 with the aid of which it is checked whether all the scanning points 12 have been processed.

The interpolation method 29 operating with a number of passes 31 to 33 and in which the ordinal data field A1 and the interpolation value data field A2 serve as buffers, offers a range of advantages.

The vector operation can be used for all the method steps with the exceptions of checking 30 at the start of the interpolation method and of the determination 33 of interpolation values and the sorting operation 40.

Carrying out the interpolation method 29 does not require the use of vector instructions that permit registers for vector operations to be filled with data that are distributed in the second-order cache 21 or in the main memory 23. The point is that with the exception of checking 30, the determination 39 of interpolation values and the sorting operation 40 the required data lie in linear storage areas that can be accessed in a timesaving fashion with vector instructions.

In addition, the occurrence of a fast forward violation is avoided by the buffering in the ordinal data field A1 and in the interpolation value data field A2. Such a fast forward violation occurs, for example, when, firstly, data are written into a storage area that is as large as a register for a vector operation, and this storage area is loaded into the corresponding vector register immediately thereafter.

However, this mode of procedure violates the fast forward strategy of modern processors 14, because the fast forward strategy does not permit small registers 19 to be allowed to write in an area that is reloaded immediately thereafter from a large register 19. If this does happen, it leads to stalling of the pipeline 28 (=pipeline stall), since it must be guaranteed that all the instructions present before the reading into the larger register have actually also been carried out and terminated. The execution of the interpolation method 29 would be substantially slowed down by the occurrence of a fast forward violation.

In the case of the interpolation method 29, both the risk of a fast forward violation and the time-consuming filling of the vector registers with vector instructions for reading dispersed data are avoided. The point is that in the case of the interpolation method 29 there is no direct writing into a storage area in the second-order cache 21 or in the main memory 23 from which there is immediate readout again, but the storage area can be made sufficiently large so that a time sufficient to avoid a fast forward violation elapses between the read operation and the write operation. Where an attempt is made during the second pass 32 to read from the interpolation value data field A2, sufficient time has elapsed since the write operation used to fill the interpolation value data field A2 with data, for no fast forward violation to have occurred. This is ensured, in particular, by virtue of the fact that during the third pass 33 the interpolation value data field A2 is read out in the same sequence in which the interpolation value data field A2 was written to in the second pass 32. Consequently, sufficient time elapses between the filling of the start of the interpolation value data field A2 and the reading out of the interpolation values in the third pass 33.

In order to avoid the fast forward violation with certainty, it is necessary, however, to take care that the size of the interpolation value data field A2 is adequately large for sufficient time to elapse between reading and writing.

A fast forward violation can also be caused when large registers 19 are used to write in a specific storage area and use is made thereafter of small registers 19 in order thereafter to read data from the storage area previously written to. In the case of the interpolation method 29, it is also possible to work with vector operation in the first pass 31, since the write operation in the first pass 31 and the read operation in the second pass 32 are decoupled by the ordinal data field A1. Enough time likewise elapses between the two operations for no fast forward violation to occur.

A further advantage of the interpolation method 29 is that no explicit caching need be set up for the implementation. The point is that, disregarding the determination 39 of interpolation values, work is carried out using computers having a first-order cache 20 and a second-order cache 21 exclusively using data that already lie in the cache 20 or 21. Moreover, the processing of the ordinal data field A1 and the interpolation value data field A2 is well suited to modern processors 14, since the cache hardware prefetching can function optimally during the linear processing.

Thus, there is no need to implement caching explicitly during the second pass 32 since, on the one hand, the program code from the first pass 31 and the third pass 33 is executed previously and subsequently, and therefore the data are not displaced from the cache 20 or 21 during the second pass 32. Otherwise, it is certainly true that distributed data are processed, but since the positions of the scanning points 12 lie next to one another, there is a need for the same interpolation point values to be read frequently directly one after another for successive scanning points 12.

Moreover, it is also possible to read interpolation point values that are already in the cache 20 or 21, since although these interpolation point values were not used just previously they were also on a cache line that was previously read. In these cases, many interpolation point values can already be taken from the cache 20 or 21, and need not be loaded from the main memory 23. An implicit caching takes place on the basis of these effects, and so there is no need to implement any explicit caching of the data.

Since the program code of the passes 31 to 33 has a simple structure, and the data in the cache 20 or 21 are not quickly displaced, the interpolation method 29 can also be parallelized for computers with a number of virtual processors 14 with a common cache (hyperthreading).

Moreover, each step of the interpolation method 29 has a simple structure, and the program code for implementing the interpolation method is consequently simple. This renders it easier both for the programmer and for the compiler to optimize the program code.

Consequently, it is possible to make use for the interpolation method 29 of a highly optimized program code that can also easily be used for other purposes. If, for example, the way in which the volume 9 is stored is changed, there is generally a need to adapt only the first pass 31, and also the pass 32, in the worst case. Conversely, in the event of a change from a fixed point interpolation to a floating point interpolation only the third pass 33 need be changed.

The use of vector operations yields the maximum gain in efficiency when the same arithmetic operations are carried out that are also carried out in a purely scalar calculation, with the difference that, at the same time, a number of scanning points 12 are treated at once. This prevents the need for a copying operation or shifting operation inside the vector register. In this respect, there is a need in the second pass 32 for a sorting operation 40 by which the interpolation point values are, if appropriate, permutated in order to ensure that the actual interpolation 44 can be carried out with the same arithmetic operations as in the case of a purely scalar calculation.

It may be remarked that saving 45 into the output data field A3 is also performed optimally in the interpolation method 29, the point being that the calculated scanning point values are written into the output data field in the correct sequence at the end of the interpolation 44.

Reference is further to be made to the fact that the determination 43 of parameters can also be carried out with the aid of vector operation. In the third pass 33, the interpolation parameters determined in this case can then flow directly into the interpolation algorithm owing to the content of vector registers.

Finally, it is to be stressed once again that a vector operation can also be used to perform the transition within the first pass 31 and the third pass 33 from a group of scanning points 12 that is processed in parallel with the aid of vector operations to the next group of scanning points 12. In the first pass 31 and the third pass 33, the calculated coordinates of the scanning points 12 can then flow directly into the interpolation method 29 by the content of vector registers.

The interpolation method 29 is explained in more detail below on the example of a bilinear interpolation in the two-dimensional volume and a trilinear interpolation in three-dimensional space. In both cases, the interpolation method is carried out with the aid of SSE and SSE2 registers.

Four scanning points 12 are processed simultaneously, since SSE registers store four floating point values each having 32 bits.

SSE and SSE2 registers can be loaded most efficiently from a storage area when the addresses of the storage area are aligned with 16 bytes, since these registers are 128 bits wide. The data fields A1 and A2 are therefore always aligned with 16 bytes.

The aim in the following example embodiments is in each case to consider the simplest case of a beam f penetrating through a volume and of scanning points 12 lying at a regular spacing on this beam. The image or volume is to be interpolated at the scanning points 12, for which it holds that f=a+nd, with n=1 . . . 4N and d=(dx, dy) in the two-dimensional case, and d=(dx, dy, dz) in the three-dimensional case. The interpolation point values are respectively present as a 16 bit=2 byte integer value.

Each scanning point 12 is defined as an integer by the fixed point arithmetic, for example as a 32 bit integer, 16 bits being used for the places in front of the point, and 16 bits for the places after the point.

The size of the voxels of the volume is intended below to be (1, 1) in the two-dimensional case, and (1, 1, 1) in the three-dimensional case. This is the size of each voxel of the volume. When the original volume is not of this size, an affine mapping is carried out such that the problem can be reduced to this simple case. This affine mapping must be applied in the same way to the scanning points 12.

Example Embodiment of a Bilinear Interpolation Along a Beam Through a Two-dimensional Image:

The interpolation result is influenced by four interpolation points 13 of the image in the case of a bilinear interpolation. Thus, when four scanning points 12 are processed in parallel it is necessary to use 4*4=16 interpolation point values of 16 bits in each case in order to determine the four result values. The surface defined by the four adjacent interpolation points 13 is respectively depicted in FIG. 2 by hatching.

First Pass:

SSE2 registers are used to determine for each scanning point 12 information items with the aid of which it is possible to determine all four adjacent interpolation points 13 that are respectively to be interpolated. The information is stored in the ordinal data field A1. The first pass 31 must be adapted to the image structure so that this information can be used in the second pass 32 in order in each case to determine the interpolation point values of the four adjacent interpolation points 13 of a scanning point 12.

In the above example, it was possible to determine the data field A1 by respectively writing the index of the left-hand, lower interpolation point 13 into the data field A1. This index is equal to the index of the respective voxel that is also denoted as a pixel in the two-dimensional case. The following data field is yielded in this case for the first four scanning points 12: A1=2, 2, 8, 9. A1=2, 2, 8, 9, 9, 15, 15, 16 is obtained here for the first eight scanning points 12.

The data field A1 is completely filled when the indices for all 4N scanning points of the beam are determined and entered into the ordinal data field A1.

Second Pass:

In the case of the simultaneous processing of four scanning points 12, the interpolation value data field A2 here includes 16 interpolation point values: D0, D1, D2, D3, D4, D5, D6, D7, D8, D9, D10, D11, D12, D13, D14, D15.

For 4N scanning points 12, the interpolation value data field A2 consists of N blocks each having four interpolation point values.

Let S1, S2, S3 and S4 be the first four scanning points 12 of the above mapping. Let the four adjacent interpolation points 13 required for the interpolation be:

For the first scanning point S1:
P1[0.0], P1[1.0], P1[0.1], P1[1.1]
   The voxels have the indices (2, 3, 8, 9) in the example.

For the second scanning point S2:
P2[0.0], P2[1.0], P2[0.1], P2[1.1]
   The voxels have the indices (2, 3, 8, 9) in the example.

For the third scanning point S3:
P3[0.0], P3[1.0], P3[0.1], P3[1.1]
   The voxels have the indices (8, 9, 14, 15) in the example.

For the fourth scanning point S4:
P4[0.0], P4[1.0], P4[0.1], P4[1.1]
   The voxels have the indices (9, 10, 15, 16) in the example.

The values of these sixteen interpolation points 13 are determined with the aid of the entries in the ordinal data field A1. The ordinal data field A1 includes here in the example the indices of Pk[0.0] (k=1, 2, 3, 4) for each scanning point Sk. The indices of the other three adjacent interpolation points Pk[1.0], Pk[0.1] and Pk[1.1] are thereby respectively uniquely defined, and it is thereby possible for all the interpolation point values Pk of the adjacent interpolation points 13 to be determined and entered into the ordinal data field A2.

The data field A2 is then filled in the following way:

DO=P1[0.0]; D1=P2[0.0]; D2=P3[0.0]; D3=P4[0.0]; D4=P1[1.0]; D5=P2[1.0]; D6=P3[1.0]; D7=P4[1.0]; D8=P1[0.1]; D9=P2[0.1]; D10=P3[0.1]; D11=P4[0.1]; D12=P1[1.1]; D13=P2[1.1]; D14=P3[1.1]; D15=P4[1.1];

The address of DO (first entry in the data field A2) is aligned with 16 bytes. All the pairs of eight (D8n, D8n+1, D8n+2, D8n+3, D8n+4, D8n+5, D8n+6, D8n+7) are thereby likewise aligned with 16 bytes and can be read with high performance using SSE2 registers.

The ordinal data field A2 is now filled in the second pass 32 by determining these data for all N blocks. The ordinal data field A2 then consists of 16*N elements.

Third Pass:

Eight interpolation point values can now respectively be loaded simultaneously in SSE2 registers 19 in an efficient fashion. These eight interpolation point values can then be distributed on two SSE2 registers, there accordingly respectively being a pair of four in one SSE2 register, and a further pair of four in the second SSE2 register as integer values. Integer values can now be converted in both registers into floating point values. Each pair of four can in this way be loaded in floating point format into an SSE register 19. Thus, four SSE registers 19: (DO, D1, D2, D3), (D4, D5, D6, D7), (D8, D9, D10, D11), (D12, D13, D14, D15) are obtained for each block of four of scanning points 12.

Thus, in each SSE register 19 the first value is always of the scanning point S1, the second that of the point S2, the third of the point S3 and the fourth of the point S4. The calculation of the bilinear interpolation can now be carried out as accurately as in the scalar case, the sole difference being that each arithmetic operation is always carried out simultaneously with four interpolation point values.

The result at the end of the calculation is an SSE register (R1, R2, R3, R4) filled with the scanning point values. Here, R1 is the result for the scanning point S1, R2 that for S2, R3 for S3 and R4 for S4. The scanning point values can now be converted into the desired format and saved in the output data field A3. Ideally, the starting point S1 is selected such that the address in the output data field A3 is aligned as favorably as possible at this point such that it is possible to write into the output data field A3 in an efficiently aligned fashion. Otherwise, it would be necessary to write in a nonaligned fashion, which would be slower and should therefore be avoided.

Two scalar parameters λ_x and λ_y are respectively required for the bilinear interpolation at each scanning point 13. These are yielded from the x and y positions of the scanning point 13 by using only the places after the point. Since these interpolation parameters are respectively required for the SIMD calculation of a block of four in the form of SSE registers, (λ_x1, λ_x2, λ_x3, λ_x4) and (λ_y1, λ_y2, λ_y3, λ_y4), these values are calculated as follows:

Let the first four discrete scanning points 12 be stored in the SSE2 registers aVector128iX, aVector128iY, each register respectively containing the x or y value of the four discrete scanning points 12 in fixed point arithmetic.

A move is made from one block of four of discrete scanning points to the next block of four by an addition:
aVector128iX+=add_{—}ddx_full
aVector128iY+=add_{—}ddy_full
with the SSE2 register add_ddx_full and add_ddy_full, where add_ddx_full=(4*dx, 4*dx, 4*dx, 4*dx) and add_ddy_full=(4*dy, 4*dy, 4*dy, 4*dy).

The interpolation parameters are calculated from aVector128ix and aVector128iY by considering only the places after the points and then converting these from SSE2 (integer) to SSE (floating point). The parameters are obtained in the desired SSE form in this way.

The described calculations can be carried out exclusively with the aid of SIMD operations.

Example Embodiment of a Trilinear Interpolation Along a Beam Through a Three-dimensional Volume:

Eight interpolation points 13 of the volume influence the interpolation result in the case of a trilinear interpolation. For four scanning points 13 it is thus necessary to use 4*8=32 interpolation point values each having 16 bits in order to determine the scanning point values.

First Pass:

SSE2 registers are used to determine for each scanning point 12 information items with the aid of which it is possible to determine all eight adjacent interpolation points 13 with the aid of which the interpolation is carried out. The information is stored in the ordinal data field A1. The first pass 31 must be adapted to the volume structure so that this information can be used in the second pass 32 in order to determine the interpolation point values of the eight adjacent interpolation points 13.

Second Pass:

Thus, for four scanning points 12 the ordinal data field A2 includes 32 interpolation point values: D0, D1, D2, D3, . . . D31. For 4N scanning points 12, the ordinal data field A2 correspondingly comprises N blocks each having 32 interpolation point values.

Let S1, S2, S3 and S4 be the four scanning points 12. Let the eight adjacent interpolation points 13 required for the interpolation be:
for the first scanning point S1:
P1[0.0.0], P1[1.0.0], P1[0.1.0], P1[1.1.0],
P1[0.0.1], P1[1.0.1], P1[0.1.1], P1[1.1.1]
For the second scanning point S2:
P2[0.0.0], P2[1.0.0], P2[0.1.0], P2[1.1.0],
P2[0.0.1], P2[1.0.1], P2[0.1.1], P2[1.1.1]
For the third scanning point S3:
P3[0.0.0], P3[1.0.0], P3[0.1.0], P3[1.1.0],
P3[0.0.1], P3[1.0.1], P3[0.1.1], P3[1.1.1]
and for the fourth scanning point S4:
P4[0.0.0], P4[1.0.0], P4[0.1.0], P4[1.1.0],
P4[0.0.1], P4[1.0.1], P4[0.1.1], P4[1.1.1]

The 32 interpolation point values are determined with the aid of the entries in the ordinal data field A1. The ordinal data field A1 could, for example, contain the address of Pk[0.0.0] (k=1, 2, 3, 4) for each scanning point Sk. However, other possibilities are also conceivable, if appropriate, depending on how the volume is constructed. When, for example, the volume is indexed in slice-wise fashion, it could contain for each scanning point 12 the slice number and the index within the slice.

The ordinal data field A2 would then be filled in the following way:

D0=P1[0.0.0]; D1=P2[0.0.0]; D2=P3[0.0.0]; D3=P4[0.0.0]; D4=P1[1.0.0]; D5=P2[1.0.0]; D6=P3[1.0.0]; D7=P4[1.0.0]; D8=P1[0.1.0]; D9=P2[0.1.0]; D10=P3[0.1.0]; D11=P4[0.1.0]; D12=P1[1.1.0]; D13=P2[1.1.0]; D13=P3[1.1.0]; D15=P4[1.1.0]; D16=P1[0.0.1]; D17=P2[0.0.1]; D18=P3[0.0.1]; D19=P4[0.0.1]; D20=P1[1.0.1]; D21=P2[1.0.1]; D22=P3[1.0.1]; D23=P4[1.0.1]; D24=P1[0.1.1]; D25=P2[0.1.1]; D26=P3[0.1.1]; D27=P4[0.1.1]; D28=P1[1.1.1]; D29=P2[1.1.1]; D30=P3[1.1.1]; D31=P4[1.1.1];

All the pairs of eight (D8n, D8n+1, D8n+2, D8n+3, D8n+4, D8n+5, D8n+6, D8n+7) are aligned with 16 bytes.

The data field A2 is now filled in the second pass 32 by determining these data for all N blocks. The data field A2 then consists of 32*N elements.

Third Pass:

The third pass 33 proceeds in accordance with the two-dimensional case. Eight SSE registers 19 are obtained here for each block of four of scanning points 12:

(D0, D1, D2, D3), (D4, D5, D6, D7), (D8, D9, D10, D11), (D12, D13, D14, D15), (D16, D17, D18, D19), (D20, D21, D22, D23), (D24, D25, D26, D27), (D28, D29, D30, D31).

Thus, in each SSE register 19 the first value is always of the scanning point S1, the second that of the scanning point S2, the third of the scanning point S3 and the fourth of the scanning point S4. The calculation of the trilinear interpolation can now be carried out as accurately as in the scalar case, the sole difference being that each arithmetic operation is always carried out simultaneously with four values.

An SSE register (R1, R2, R3, R4) is obtained at the end of the calculation, R1 being the result for the point S1, R2 that for S2, R3 for S3 and R4 for S4. The scanning point values can now be converted into the desired format and saved in the output data field A3.

Three scalar parameters λ_x, λ_y and λ_z are respectively required for the trilinear interpolation at each scanning point 12. These are yielded from the x, y and z positions of the scanning point 12 by using only the places after the points. As in the two-dimensional case, the interpolation parameters are required in the form of SSE registers (λ_x1, λ_x2, λ_x3, λ_x4), (λ_y1, λ_y2, λ_y3, λ_y4) and (λ_z1, λ_z2, λ_z3, λ_z4).

The calculation of the interpolation parameters is performed as for the calculation in the two-dimensional case.

The four scanning points 12 are stored in three SSE2 registers aVector128ix, aVector128iY and aVector128iZ.

A move is made from one block of four to the next by
aVector128iX+=add_{—}ddx_full
aVector128iY+=add_{—}ddy_full
aVector128iZ+=add_{—}ddz_full
with the aid of an SSE2 register add_ddz_full=(4*dz, 4*dz, 4*dz, 4*dz), which is new by comparison with the two-dimensional case.

It may be remarked that the output data field A3 should also be aligned with 16 bytes if possible. When the start address of the output data field may not be freely selected, and the start address is not aligned with 16 bytes, an area of the output data field should be found that is aligned with 16 bytes and lies entirely in the interior of the output data field A3. The vector operations should then be applied to this area in the course of the multipass strategy. The first and the last values of the output data field A3 that do not lie in this area can then be determined with the aid of a scalar interpolation algorithm.

When the interpolation method 29 is to be applied to an extensive set of scanning points 12, it is not necessary for the data fields A1 and A2 to be selected to be so large that all the scanning points 12 are processed in each of the passes 31 to 33. It is recommended here to subdivide the set of scanning points 12 into small subsets and to interpolate each subset with the aid of the above interpolation method 29. The size of the data fields A1 and A2 is thereby kept small.

An interpolation value data field A2, for which it holds that N=1, something which corresponds to four scanning points 12 in the exemplary embodiments described here, is generally too small in order to be able to be used efficiently. Specifically, with this size of interpolation value data field A2 there is the risk of initiating a fast forward violation. Whether a fast forward violation actually is initiated depends on how the interpolation method 29 is implemented and how the compiler converts the code into assembler code.

It should therefore advantageously hold that N>1. This is generally fulfilled when the interpolation method is applied to an entire beam, a block of an image or an entire volume. As a result, there is more independence from the implementation and a fast forward violation is reliably circumvented.

In the case of an example embodiment of a method with beam tracing, the general aim is to interpolate not an entire beam, but only a subregion, since it is desired to jump over parts of the volume or to terminate the beam prematurely. It is recommended here to select at least N=2, that is to say to make use in the examples of eight scanning points each time the interpolation method 29 is invoked. When it is intended, nevertheless, to use N=1, care must be taken in the implementation that the read and write operations are planned such that no fast forward violation situation occurs, for example by carrying out other operations between the reading and writing that requires sufficient time.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for interpolating volume data, comprising:
determining, using a processor, interpolation points assigned to a set of scanning points; and
performing an interpolation from interpolation point values of the determined interpolation points to scanning point values to be assigned to the scanning points, the interpolation point values of the determined interpolation points being buffered in a linear interpolation value storage area of a memory unit, wherein vector operation is used to interpolate to the scanning point values.

2. The method as claimed in claim 1, wherein vector operation is used to read out the interpolation value storage area.

3. The method as claimed in claim 1, wherein the interpolation value storage area is optimized for data access via vector operation.

4. The method as claimed in claim 1, wherein the interpolation value storage area is filled with more interpolation values than are loadable into a register for vector operation by way of a single load instruction.

5. The method as claimed in claim 1, wherein ordinal data of the interpolation points are firstly determined.

6. The method as claimed in claim 5, wherein a vector operation is used to determine the ordinal data of the interpolation points.

7. The method as claimed in claim 5, wherein the determined ordinal data are buffered in a linear ordinal data storage area.

8. The method as claimed in claim 7, wherein vector operation is used to store the ordinal data in the ordinal data storage area.

9. The method as claimed in claim 7, wherein scalar operations are used to determine the interpolation point values with the aid of the ordinal data stored in the ordinal data storage area.

10. The method as claimed in claim 7, wherein vector operation is used to optimize the ordinal data storage area for data access.

11. The method as claimed in claim 7, wherein more ordinal data are stored in the ordinal data storage area than is loadable into a register for vector operation by way of a single load instruction.

12. The method as claimed in claim 5, wherein index data are determined as ordinal data.

13. The method as claimed in claim 1, wherein the vector operation is carried out with the aid of SIMD.

14. The method as claimed in claim 1, wherein an interpolation is carried out for a multiplanar reconstruction of medical volume data.

15. An apparatus for interpolating volume data, comprising:
means for determining interpolation points assigned to a set of scanning points; and
means for performing an interpolation from interpolation point values of the determined interpolation points to scanning point values to be assigned to the scanning points, the interpolation point values of the determined interpolation points being buffered in a linear interpolation value storage area of a memory unit, wherein vector operation is used to interpolate to the scanning point values.

16. A computer program product for evaluating data, including program code for, when executed on a computer device, executing a method as claimed in claim 1.

17. The method as claimed in claim 2, wherein the interpolation value storage area is optimized for data access via vector operation.

18. The method as claimed in claim 6, wherein the determined ordinal data are buffered in a linear ordinal data storage area.

19. The method as claimed in claim 8, wherein scalar operations are used to determine the interpolation point values with the aid of the ordinal data stored in the ordinal data storage area.

20. A computer readable medium for evaluation of data, including program code for, when executed on a computer device, carrying out a method as claimed in claim 1.
